(19) United States
(12) Patent Application Publication
(10) Pub. No.: US 2005/0192201 A1
(43) Pub. Date: Sep. 1, 2005

(54) Dishwashing wipe

(76) Inventors: Francis Cornelio Ford, Cincinnati, OH (US); Denis Gerard O'Sullivan, Bruxelles (BE); Peter Robert Foley, Cincinnati, OH (US); Jeffrey Lee Butterbaugh, Cincinnati, OH (US); Jaydeep Jawaharlal Mody, Cincinnati, OH (US); Leonardus Dennis Schickendantz, Grimbergen (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/043,546

(22) Filed: Jan. 26, 2005

Related U.S. Application Data
(60) Provisional application No. 60/539,295, filed on Jan. 26, 2004.
(60) Provisional application No. 60/577,701, filed on Jun. 7, 2004.

(51) Int. Cl. C11D 17/00

(52) U.S. Cl. 510/438

(57) ABSTRACT

A dishwashing wipe including a water insoluble substrate and at least a first and a second surfactant-containing cleaning composition, wherein the first composition releases surfactant at a rate of at least 0.6 g surfactant/minute and the second composition releases surfactant at a rate of 0.5 g surfactant/minute or less.

### CROSS REFERENCE TO RELATED APPLICATIONS

This application claims priority to U.S. Provisional Application Ser. No. 60/539,295, filed Jan. 26, 2004, and U.S. Provisional Application Ser. No. 60/577,701, filed Jan. 26, 2004, the disclosures of which are incorporated by reference.

### TECHNICAL FIELD

The present invention relates to wipes, specifically dishwashing wipes comprising a water insoluble substrate and at least a first and a second cleaning composition. The first and second compositions comprise surfactant and thus on dissolution, produce suds.

### BACKGROUND OF THE INVENTION

Dish care products, particularly hand dishwashing products, have traditionally been marketed in a variety of forms such as scouring powders, pastes, aqueous liquids and gels. Recently the focus has been on the development of dishcare products in the form of a wipe. More specifically a disposable wipe comprising already incorporated cleaning composition. One problem with such executions however has been the rate of dispensing of the cleaning composition from the wipe. Whether the wipe is wet or dry, the cleaning composition, which must be water-soluble in order to be effective on the dishware, leaks quickly into the wash water and solubilises. At this point the wash water contains the cleaning composition and the wipe is merely used as a dishcloth. As with regular dishwashing products dispensed from bottles, the suds generated immediately on addition of the surfactant-containing cleaning composition to the wash water, die or dissipate over time. This is a negative signal to the consumer, who generally believes that when there are no more suds, there is no more efficacy. It has therefore been an objective of the dishwashing detergent manufacturer to develop dishwashing detergents that maintain suds for an extended period. Providing the dishwashing detergent by way of the wipe offers the detergent manufacturer the opportunity to control the release of surfactant and thus to control the generation of suds throughout the wash.

The Applicants have developed technology for delaying the release of suds from the wipe to the wash water, described in detail in our copending application (attorney docket numbers CM2691FP and CM2779FP). However the Applicant has since found that whilst such technology does indeed afford suds mileage to the system, a consequence however is that suds are not generated at a significant rate at the start of the wash when the wipe is first moistened with wash water. This slow generation of suds at the start of the wash gives the consumer the impression of lack of efficacy and as such is not preferred. Having understood this problem, the Applicant has thus sought to develop a method of providing suds immediately on contact with water, known as ‘flash suds’ and secondly, suds over an extended period of time, known as ‘mileage suds’.

### SUMMARY OF THE INVENTION

According to the present invention there is provided a dishwashing wipe comprising a water insoluble substrate and at least a first and a second surfactant-containing cleaning composition, wherein the first composition releases surfactant at a rate of at least 0.6 g surfactant/minute and the second composition releases surfactant at a rate of 0.5 g surfactant/minute or less.

### DETAILED DESCRIPTION OF THE INVENTION

The wipes of the present invention comprise a first and second composition that are released from the wipe at different rates. The first composition is released more quickly than the second composition. The difference in rate of release may be achieved by chemical and/or physical means. Chemical means might include for example the inclusion of either dissolution aids or dissolution retarding agents to increase or decrease the rate of dissolution respectively. Alternatively physical means may include exposing the first composition at a point where it can be activated by the wash water as soon as available. Whereas the second composition may be applied to inner layers and surfaces of the wipe, or between two layers of water soluble or insoluble film to delay or limit access of wash water.

As used herein, “disposable” is used in its ordinary sense to mean an article that is disposed or discarded after a limited number of usage events, preferably less than about 15, more preferably less than about 10, and most preferably less than about 5 usage events. For example, a usage event in a hand dishcare operation is defined as being the cleaning by hand dishwashing of a load of dishes that accumulates during one day in a four person family household.

In a preferred embodiment herein the disposable wipes according to the present invention are dry-to-the-touch. By ‘dry-to-the-touch’ it is meant that the wipes are substantially free of water or other solvents in an amount that would make them feel damp or wet to the touch as compared to the touch of a wet wipe or pre-moistened wipe, wherein a substrate is impregnated (i.e., soaked) in a liquid. The wipes according to the present invention preferably remain dry-to-the-touch until it is required for use in cleaning a surface as described herein, this means until they are intentionally moistened with water in the process of cleaning a surface, preferably dishware, according to the present invention.

The wipes of the present invention are preferably water-activated and are therefore intended to be moistened with water prior to use. As used herein, “water-activated” means that the present invention is presented to the consumer in dry-to-the-touch form to be used after wetting/moistening with water. Accordingly, the wipe is moistened by contacting it with water, including dipping or immersion in water or by placing it under a stream of water.

The wipes according to the present invention may have a length of from about 10 to about 20 cm, a width of from about 10 to about 20 cm and a thickness of from about 2 to about 5 mm.

The wipes of the present invention comprise a water-insoluble substrate, which preferably comprises at least two layers. The layers herein have an interior and exterior surface. The interior surfaces of the layers are those which face the inside or innermost portion of the wipe of the present invention whereas the exterior surfaces of the layers are those which face the outside or outermost portion of the wipe. One or more additional layers may be present between said two layers.

The substrate layers of the wipe are normally designed for different applications and thus preferably have different textures. Hence one layer may be designed for scrubbing tough to remove soils, such as burnt-on, baked-on soils. This scrubbing layer is therefore comparatively more abrasive than the other, comparatively softer cleaning layer.

The layers, as well as any additional layers, are preferably bonded to one another in order to maintain the integrity of the wipe. The layers are preferably heat spot bonded together, more preferably the wipes are high pressure welded. The bonding may be arranged such that geometric shapes and patterns, e.g. diamonds, circles, squares, etc., are created on the exterior surfaces of the layers and the resulting wipe.

The substrate is preferably flexible and even more preferably the substrate is also resilient, meaning that once applied external pressure has been removed the substrate regains it's original shape.

The layers may preferably be selected from nonwoven fibers or paper. The term nonwoven is to be defined according to the commonly known definition provided by the “Nonwoven Fabrics Handbook” published by the Association of the Nonwoven Fabric Industry. A paper substrate is defined by EDANA (note 1 of ISO 9092-EN 29092) as a substrate comprising more than 50% by mass of its fibrous content is made up of fibres (excluding chemically digested vegetable fibres) with a length to diameter ratio of greater than 300, and more preferably also has density of less than 0.040 g/cm³. To be clear, the definitions of both nonwoven and paper substrates do not include woven fabric or cloth or sponge. The layers are preferably partially or fully permeable to water and the cleaning compositions.

The substrate may comprise natural or synthetic fibres. Natural fibres include all those which are naturally available without being modified, regenerated or produced by man and are generated from plants, animals, insects or by-products of plants, animals and insects. Preferred examples of natural fibres include keratin fibres and cellulosic fibres, including wood pulp, cotton, hemp, jute, fax and combinations thereof. Natural material nonwovens useful in the present invention may be obtained from a wide variety of commercial sources. Nonlimiting examples of suitable commercially available paper useful herein include Airtex®, an embossed airlaid cellulosic having a base weight of about 71 gsm, available from James River, Green Bay, Wis.; and Walkisoft®, an embossed airlaid cellulosic having a base weight of about 75 gsm, available from Walkisoft U.S.A., Mount Holly, N.C.

As used herein, “synthetic” means that the materials are obtained primarily from various man-made materials or from natural materials that have been further altered. Nonlimiting examples of synthetic materials useful in the present invention include those selected from the group consisting of acetate fibers, acrylic fibers, cellulose ester fibers, modacrylic fibers, polyamide fibers, polyester fibers, polyolefin fibers, polyvinyl alcohol fibers, rayon fibers and combinations thereof. Examples of suitable synthetic materials include acrylics such as acrilan, creslan, and the acrylonitrile-based fiber, orlon; cellulose ester fibers such as cellulose acetate, arnel, and acele; polyamides such as nylons (e.g., nylon 6, nylon 66, nylon 610, and the like); polyesters such as fortrel, kodel, and the polyethylene terephthalate fiber, polybutylene terephalate fiber, dacron; polyolefins such as polypropylene, polyethylene; polyvinyl acetate fibers and combinations thereof. These and other suitable fibers and the nonwovens prepared therefrom are generally described in Riedel, “Nonwoven Bonding Methods and Materials,” Nonwoven World (1987); The Encyclopedia Americana, vol. 11, pp. 147-153, and vol. 26, pp. 566-581 (1984); U.S. Pat. No. 4,891,227, to Thaman et al., issued Jan. 2, 1990; and U.S. Pat. No. 4,891,228, each of which is incorporated by reference herein in its entirety.

Preferred polyolefin fibers are fibers selected from the group consisting of polyethylene, polypropylene, polybutylene, polypentene, and combinations and copolymers thereof. More preferred polyolefin fibers are fibers selected from the group consisting of polyethylene, polypropylene, and combinations and opolymers thereof. Preferred polyester fibers are fibers selected from the group consisting of polyethylene terephthalate, polybutylene terephthalate, polycyclohexylenedimethylene terephthalate, and combinations and copolymers thereof. More preferred polyester fibers are fibers selected from the group consisting of polyethylene terephthalate, polybutylene terephthalate, and combinations and copolymers thereof. Most preferred synthetic fibers of the first layer comprise solid staple polyester fibers, which comprise polyethylene terephthalate homopolymers. Suitable synthetic materials may include solid single component (i.e., chemically homogeneous) fibers, multiconstituent fibers (i.e., more than one type of material making up each fiber), and multicomponent fibers (i.e., synthetic fibers which comprise two or more distinct filament types which are somehow intertwined to produce a larger fiber), hollow fibers and combinations thereof. Preferred fibers include bicomponent fibers, multiconstituent fibers, and combinations thereof. Such bicomponent fibers may have a core-sheath configuration or a side-by-side configuration. In either instance, the first layer may comprise either a combination of fibers comprising the above-listed materials or fibers which themselves comprise a combination of the above-listed materials.

Methods of making nonwovens are well known in the art. Generally, these nonwovens can be made by air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed.

In addition to the fibres used to make the substrate, the substrate can comprise other components or materials added thereto as known in the art, including binders, dry strength and lint control additives.

In a preferred embodiment the cleaning substrate is a partially hydrophobic nonwoven. By “partially hydrophobic” it is meant herein that the nonwoven at least partially comprises hydrophobic material. Preferably the nonwoven substrate comprises at least about 40%, more preferably at least about 50%, even more preferably from about 55% to about 75% hydrophobic material. Hydrophobic materials are generally based on synthetic organic polymers. Suitable hydrophobic materials herein are selected from the group consisting of synthetic organic polymers such as, acrylic fibers, modacrylic fibers, polyamide fibers, polyester fibers, polyolefin fibers, polyethylene foam, polyurethane foam, and combinations thereof. Examples of suitable synthetic materials include acrylics such as acrilan, creslan, and the acrylonitrile-based fiber, orlon; polyamides such as nylons (e.g., nylon 6, nylon 66, nylon 610, and the like); polyesters such as fortrel, kodel, and the polyethylene terephthalate fiber, polybutylene terephthalate fiber, dacron; polyolefins such as polypropylene, polyethylene, and polyurethane foams. Preferably, said hydrophobic materials herein are selected from the group consisting of polyamides, polyethylene terephthalate, and polyolefins. More preferably said partially hydrophobic nonwoven of said cleaning layer comprises a carded, hydroentangled substrate comprising 60% polypropylene and 40% rayon fibres.

Hydrophobic materials suitable for the cleaning layer are selected from the group consisting of cellulosic nonwovens, non-lofty nonwovens, and absorbent nonwovens and combinations thereof. Preferably the substrate of the cleaning layer in this emodiement is a non-lofty nonwoven substrate.

The substrate preferably has a weight of from about 20 gm⁻² to about 200 gm⁻². More preferably, the substrate has a weight of at least about 20 gm⁻² and more preferably less than about 150 gm⁻², more preferably the base weight is in the range of about 20 gm⁻² to about 120 gm⁻², and most preferably from about 30 gm⁻² to about 110 gm⁻². The substrate may have any caliper. Typically, when the substrate is made by hydroentangling, the average substrate caliper is less than about 1.2 mm at a pressure of about 0.1 pounds per square inch. More preferably the average caliper of the substrate is from about 0.1 mm to about 1.0 mm at a pressure of about 0.1 pounds per square inch (about 0.007 kilograms per square meter). The substrate caliper is measured according to standard EDANA nonwoven industry methodology, reference method # 30.4-89.

In the most preferred embodiment according to the present invention said cleaning layer is a carded, spunlaced partially hydrophobic nonwoven.

In another preferred embodiment according to the present invention said partially hydrophobic nonwoven of said cleaning layer consists of at least about 40%, preferably of from about 50% to about 75%, more preferably of from about 55% to about 65% of synthetic fibres.

Preferably the substrate comprises a layer which is comparatively more abrasive than the opposing layer. The abrasive nature of the layer may be provided by a substrate which is inherently abrasive or a substrate wherein the abrasiveness is provided by additional elements adhered or in some way fixed to the substrate.

In one embodiment of the present invention the scrubbing substrate comprises an abrasive net of fibres, otherwise known as a scrim. By the term ‘net’ it is meant a structure made directly from melts or fibres which are at least 0.2 mm long and are held together by systems other than hydrogen bonding. The fibres may be selected from metal, natural or synthetic wires, filaments or stands or mixtures thereof as long as the resulting web provides a surface which is more abrasive than the cleaning substrate. Preferred fibres are selected from those of synthetic organic origin, more preferably from polymeric synthetic organic origin and thermoplastic polymers. The fibres are preferably selected from polyamide, polyethylene, polypropylene fibres and mixtures thereof.

In one embodiment of the present invention the first composition is substantially located on an external surface of the wipe. In said embodiment the first composition is preferably applied in a thin layer to a part or all of the surface area of one or both external surfaces of the wipe. The first composition may be sprayed or slot coated onto the external surface of the wipe. Such a procedure is achieved using standard wipe processing and composition application machinery available on the market and know to the wipe manufacturer.

### Additional Layers

Optionally, but preferably the wipe may comprise more than 2 layers of substrate. In one preferred embodiment the wipe comprises an additional layer made from a lofty substrate, more preferably a batting substrate. Batting is defined according to the TAPPI Association of the Nonwoven Fabrics Industry as a soft bulky assembly of fibres. Batting preferably comprises synthetic materials as described in more detail above.

Preferably the wipe comprises a lofty substrate layer, more preferably at least two lofty substrate layers. In one embodiment of the present invention the second composition is substantially located between said batting layers.

In a further preferred embodiment according to the present invention, the water-insoluble substrate herein additionally comprises at least one substantially water-impermeable layer again located in-between said outer layer. By ‘substantially water-impermeable’ it is meant herein that the layer has a low but not significant level of permeability for water.

Preferably, said substantially water-impermeable layer is a plastic film, more preferably a plastic film made from linear low density polyethylene (LDPE) and metallocene catalyzed low density polyethylene. In a preferred embodiment of the present invention the wipe comprises at least two water-impermeable layers. More preferable said two layers are juxtaposed. In said embodiment the second cleaning composition is preferably substantially located between said layers. Preferably, said plastic film has a thickness of about 0.8 mm. Preferably, said water-impermeable layer has an embossed micropattern. It has been found that such an embossed micropattern provides low noise during use. A suitable material for said water-impermeable layer is commercially available from Tregedar under the trade name EMB-685®.

Alternatively the substrate may comprise a water-insoluble film which has been pre-perforated or apertured such that it is then at least partially water permeable. Preferably said films comprise apertures covering 2% to 50%, more preferably from 2% to 20% of the surface area of the film. Examples of such films include materials from PGI nonwovens comprising LDPE perforated in a hex pattern via macro dot embossing with 17% and 38% open area. Other materials from Tredegar under the vispire polymer brand using LDPE or LDPE/HDPE blends with 20-40 hex pattern embossing and 5-20% open area are also suitable. In one preferred embodiment the second composition is applied between one layer of water-impermeable polyethylene film and a second partially-permeable film

Alternatively the wipe may comprise at least one but preferably two layers of water-soluble film, preferably a water-soluble polymeric film. As above it is preferred that the second composition is substantially located between or on the layer(s) of water soluble film. This particular film aids to delay dissolution of the second composition as dissipation of the composition into the wash water is retarded further owing to the presence of the film. As the film dissolves through the wash, more wash water is admitted to the wipe thus permitting control of the extent of water admitted to the wipe and thus the extent to which the composition may dissolve. Water soluble films may be prepared in situ via co-extrusion of the cleaning composition with PVOH. Suitable commercially available PVOH films are available from Dupont.

### Cleaning Composition

The wipe of the present invention comprises a first and a second surfactant-containing cleaning composition. The first composition provides an initial release of surfactant and thus an initial generation of suds, at a rate of at least 0.6 g surfactant/minute. The first cleaning composition dissolves relatively more quickly on contact with water, as compared to the second composition and is preferably substantially located near or on the external surface of the wipe. The first composition is described as being unsustained, by which it is meant that the composition is exhausted before the end of the washing process. The first composition is designed so as to have been exhausted within the first 60 seconds, more preferably the first 30 seconds after contact of the first composition and the wash water. This design feature meets the consumer needs for whom it is relevant to produce suds within the first 10 to 20 seconds of the washing process. The second composition provides a constant and sustained release of surfactant of 0.5 g surfactant/minute or less. The cleaning composition dissolves relatively more slowly than the first composition. The second composition also begins dissolving on contact with water, but because of the slower rate of release of surfactant into the wash water, suds are produced throughout the cleaning process. The wipe is described to be exhausted once said second composition is entirely exhausted.

### The First Composition

In a preferred embodiment the first composition provides an initial, unsustained release of surfactant of from 0.6 g to 4.0 g surfactant/minute. In a further preferred embodiment the second composition provides a constant sustained release of surfactant of from 0.005 g to 0.5 g of surfactant/minute.

The first composition preferably comprises a dissolution aid selected from at least 15% water, hydrotope, diols, monohydric alcohols, polyglycols and mixtures thereof. Examples of preferred hydrotopes include sodium benzene sulphonate, sodium xylene sulphonate, sodium cumene sulphonate, sodium naphthalene sulfonate and mixtures thereof. Preferred diols include cyclohexane dimethanol, trimethyl pentane diol, tetramethyl pentane diol, 1,6 hexane diol and mixture thereof. Preferred alcohols include ethanol, propanol, butanol, pentanol, hexanol and mixtures thereof. Preferred polymeric glycols including polyethylene glycol of molecular weight between 200 and 4000, polyethylene glycol adipate, polypropylene glycol of molecular weight between 1000 and 3000, polybutylene glycol and mixtures thereof.

Preferably the first composition covers in the range of from 10% to 100% of the external surface area of the wipe. By the external surface area of the wipe it is meant the surface area of both external faces of the wipe and not including the surface area provided by internal surfaces and layers of substrate. However where one of the outer layers is a net or scrim, the first composition is applied to the surface underlying the scrim. Detergent can not be absorbed into or adsorbed onto the external surface of the scrim and because it is water-permeable, applying the composition to the layer under the scrim permits equivalent wash water access as if the composition had been applied to the external surface of the wipe itself.

Preferably the entire surface area of the wipe is between 5000 mm2 and 30,000 mm2. Preferably the first cleaning composition covers from 2000 mm2 to 12,000 mm2 of the surface area of the external surfaces of the wipe. The minimum area for coverage that provides appreciable initial suds is at least 10% of the total surface area. Wipes comprising the first cleaning composition covering greater than 40% of the entire wipe surface area lead to higher release rate of detergent. In a particularly preferred embodiment the first composition is application to the external surface of the wipe in a thickness of film less than 1 mm. A thickness of 1 mm and area of 2000 mm2 will give the minimum surfactant release rate of surfactant of 0.6 g surfactant/minute. Preferably the first composition is present such that between 100 g/m2 to 2000 g/m2 of the external surface of the wipe

The first composition preferably comprises surfactant at a minimum of 20% by weight of the composition. Surfactants can be selected from the list of surfactants described later. Preferred surfactants are selected from alkyl ethoxy sulphates, amine oxide, ethoxylated alcohol nonionics and mixtures thereof. The first composition preferably comprises a dissolution aid at a level of from 0.5%. Preferred dissolution aids include ethanol, sodium cumene and toluene sulfonates, polyglycol ethers and mixtures thereof. The weight of the first composition is kept to a minimum to produce high suds immediately on contact with water, without negatively impacting rinsing. The weight ratio of first composition to second composition is from 1:6 to 1:2 respectively.

### The Second Composition

The second composition preferably comprises a dissolution-retarding agent selected from less than 12% water, polymers, inorganic salts and mixtures thereof. Preferred polymers include water-soluble thickening polymers having anionic side chains. The anionic side chains are preferably selected from carboxylate, hydroxyl and other groups capable of exhibiting hydrogen bonding. A particularly preferred class of polymers include the polysaccharides and polysaccharide derivative polymers. Preferably the polysaccharide or polysaccharide derivative has an average molecular weight of 1×10⁵ to 9×10⁷, preferably 5×10⁵ to 5×10⁶. More particularly the polysaccharide or polysaccharide derivative is selected from the group consisting of xanthan gum, cellulose, modified cellulose such as methyl cellulose, hydroxyl propyl methyl cellulose, guar gum, gellan, carragheenan, gum arabic and mixtures thereof. Preferably the polysaccharide or polysaccharide derivative is selected from the group consisting of xanthan gum and guar gum. Most preferred is xanthan gum, preferably with an average molecular weight of approximately 10⁶. Derivatives of xanthan gum can be used provided they retain the anionic side chains and, preferably, hydroxyl groups. Other useful polymers include polacrylates, polyacrylate/maleate copolymers, polyvinylalcohol/acetate copolymers, polyaspartic acid polymers, polyvinyl pyrrolidone, poly vinyl pyridine N-oxide, polyethylene glycol polymers of average molecular weight greater than 8000 and mixtures thereof.

Other preferred dissolution-retarding agents include insoluble salts such as fumed silica (SiO2), diatomaceous earth (SiO2), Talc (MgAlSiO3), calcium carbonate, calcium or magnesium hydroxide, sodium silicate, sodium borate and mixtures thereof.

The second composition preferably comprises surfactant at a minimum level of 65% by weight of the composition. The surfactant may be selected from any of the surfactants described hereinafter. Preferred surfactants are selected from alkyl ethoxy sulphates, amine oxide, ethoxylated alcohol nonionics and mixtures thereof. The second composition preferably comprises a dissolution-retarding agent at a level of at least 2% by weight of the composition. The dissolution-retarding agent is preferably selected from the group consisting polyvinyl alcohol, polyacrylic acid, xanthan gum, fumed silica, talc calcium carbonate and mixtures thereof.

In a preferred aspect of the present invention the composition is in the form of a paste. By ‘paste’ it is meant herein that the material is in a solid state and does not continuously change its shape when subjected to a given yield stress.

The second cleaning composition is preferably applied onto the interior surface of one or several layer(s) of the substrate of the wipe. Alternatively, but preferably the second composition is applied onto either the inner or outer facing surface of an additional layer located between the outer layers of the wipe.

The cleaning composition herein may be equally distributed over the full surface of the layer it is deposited on or applied onto a part of the surface of the layer(s) it is deposited on. In a preferred embodiment, the cleaning composition is applied onto parts of at least one of the layers herein, preferably an internal layer, in a stripe pattern. More preferably, said stripe pattern comprises at least 1 stripe, preferably of from about 1 to about 6 stripes, more preferably about 3 to about 6 stripes, and even more preferably 5 stripes. Preferably, the stripe or stripes of the stripe pattern extend over the full length of the substrate. The stripe or stripes of the stripe pattern may have a width of at least about 3 mm, preferably of from about 5 mm to about 15 mm.

In a particularly preferred embodiment of the present invention, the cleaning composition, more preferably at least the second composition, comprises a colouring agent, for example and ink, dye or pigment. The cleaning composition may comprise one colouring agent and thus all be the same colour. Alternatively however it is also envisaged that different stripes of the cleaning composition may be differently coloured. Additionally different coloured stripes of cleaning composition could be used to indicate the presence of different ingredients in the cleaning composition. For example a bleach-containing stripe of cleaning composition may be differently coloured to a surfactant- or enzyme-containing cleaning composition stripe. It is envisaged that the cleaning composition may be the same or similar colour to the active and/or permanent graphic. Alternatively it is also envisaged that the cleaning composition, active and/or permanent graphic may be individually different colours.

In a preferred embodiment herein, the cleaning composition herein covers at least about 30% of the surface of at least one of the layers herein, preferably, the cleaning composition herein covers of from about 40% to about 60% of the surface of at least one of the layers herein.

The wipes of the present invention comprise from about 10% to about 1,000%, preferably from about 50% to about 600%, and more preferably from about 100% to about 250%, based on the weight of the water insoluble substrate, of the second cleaning composition. The wipes of the present invention preferably comprise at least about 4.5 grams of said second cleaning composition.

### Surfactant

The compositions of the present invention comprise a surfactant. Surfactants may be selected from the group consisting of amphoteric, zwitterionic, nonionic, anionic, cationic surfactants and mixtures thereof. Suitable such surfactants are those commonly used in detergent compositions.

Preferred amphoteric surfactants useful in the present invention are selected from amine oxide surfactants. Amine oxides are semi-polar nonionic surfactants and include water-soluble amine oxides containing one alkyl moiety of from 10 to 18 carbon atoms and 2 moieties selected from the group consisting of alkyl groups and hydroxyalkyl groups containing from 1 to 3 carbon atoms; water-soluble phosphine oxides containing one alkyl moiety of from 10 to 18 carbon atoms and 2 moieties selected from the group consisting of alkyl groups and hydroxyalkyl groups containing from 1 to 3 carbon atoms; and water-soluble sulfoxides containing one alkyl moiety of from 10 to 18 carbon atoms and a moiety selected from the group consisting of alkyl and hydroxyalkyl moieties of from 1 to 3 carbon atoms. Preferred amine oxide surfactants in particular include C₁₀-C₁₈ alkyl dimethyl amine oxides and C₈-C₁₂ alkoxy ethyl dihydroxy ethyl amine oxides.

Other suitable, non-limiting examples of amphoteric detergent surfactants that are useful in the present invention include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group. Preferably the amphoteric surfactant where present, is present in the composition in an effective amount, more preferably from 0.1% to 20%, even more preferably 0.1% to 15%, even more preferably still from 0.5% to 10%, by weight.

Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. The preferred alkylpolyglycosides have the formula R²O(CₙH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18, preferably from 12 to 14, carbon atoms; n is 2 or 3, preferably 2; t is from 0 to 10, preferably 0; and x is from 1.3 to 10, preferably from 1.3 to 3, most preferably from 1.3 to 2.7. The glycosyl is preferably derived from glucose. To prepare these compounds, the alcohol or alkylpolyethoy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Fatty acid amide surfactants having the formula: 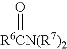
wherein R⁶ is an alkyl group containing from 7 to 21 (preferably from 9 to 17) carbon atoms and each R⁷ is selected from the group consisting of hydrogen, C₁-C₄ alkyl, C₁-C₄ hydroxyalkyl, and —(C²H₄O)ₓH where x varies from 1 to 3. Preferred amides are C₈-C₂₀ ammonia amides, monoethanolamides, diethanolamides, and isopropanolamides.

Preferably the nonionic surfactant, when present in the composition, is present in an effective amount, more preferably from 0.1% to 20%, even more preferably 0.1% to 15%, even more preferably still from 0.5% to 10%, by weight.

Anionic surfactants are preferred components of the compositions of the present invention. Suitable anionic surfactants for use in the compositions herein include water-soluble salts or acids of C₆-C₂₀ linear or branched hydrocarbyl, preferably an alkyl, hydroxyalkyl or alkylaryl, having a C₁₀-C₂₀ hydrocarbyl component, more preferably a C₁₀-C₁₄ alkyl or hydroxyalkyl, sulphate or sulphonates. SySuitable counterions include H, alkali metal cation or ammonium or substituted ammonium, but preferably sodium.

Where the hydrocarbyl chain is branched, it preferably comprises C1-4 alkyl branching units. The average percentage branching of the anionic surfactant is preferably greater than 30%, more preferably from 35% to 80% and most preferably from 40% to 60%.

The anionic surfactant is preferably present at a level of at least 15%, more preferably from 20% to 40% and most preferably from 25% to 40% by weight of the total composition.

### Water Transfer Agent

Suitable water transfer agents are particulate materials which are capable of absorbing free water from the composition, in particular free water associated with the surfactant and/or the bleach. The water transfer agent is capable of withdrawing water from the surfactant. By “capable of withdrawing water from the surfactant” it is meant that there is a greater affinity between water and the water-transfer agent than there is between water and the surfactant.

In a preferred embodiment of the invention the water-transfer agent is selected from the group consisting of inorganic oxides and salts, especially hydratable oxides and salts, in particular oxides and salts of silicon, aluminium, zinc, boron, phosphorus, alkaline earth metals and alkali metals and mixtures thereof. Examples include silicates, silicic acid and silica, citric acid, citrates, sodium and potassium tripolyphosphates, sodium and potassium sulfates, magnesium and calcium sulfates. Preferably, the water-transfer agent is selected from the group consisting of silica, salts of magnesium and mixtures thereof.

More preferably the water-transfer agent is silica, preferably amorphous fumed silica. Hydrophobic silica does not act as water transfer agent as it does not possess the necessary hydrophilicity. Preferably the water transfer agent has surface area measured by BET (described in DIN 66131 and as originally described in JACS, Vol. 60, 1938, p 309 by Brunauer, Emmet and Teller) of from 5 to 800 m²/g. More preferably the water-transfer agent has a surface area of from 100 to 400 m²/g. In an alternative preferred embodiment, the silica has an average particle size of from 0.05 to 1 μm, preferably from 0.2 to 0.3 μm.

Preferably the composition applied to the substrate comprises from 2.5 to 15% water-transfer agent, more preferably 5 to 10% and most preferably about 6%.

### Bleach

In a particularly preferred embodiment of the present invention the first and second cleaning compositions comprise a bleach or bleach system. Any bleach known for detergent use may be used, as appropriate. Preferably the bleach is chosen from aliphatic C₁-C₂₂ peroxy carboxylic acids and precursors thereof, in particular aliphatic C₉ to C₁₆ peroxy carboxylic acids and precursors thereof. Particularly suitable peroxy carboxylic acids in this class include pernonanoic acid, n-nonanoyl-6-aminopercaproic acid and diperoxydodecane dioic acid.

Other preferred bleaches are aromatic C₇ to C₃₀ peroxy carboxylic acids and precursors thereof, preferably C₇ to C₂₀ heteroaromatic peroxy carboxylic acids. Particularly preferred examples include phthalimidoperoxyhexanoic acid (PAP), described in EP-A-349940, and other compounds of the formula: 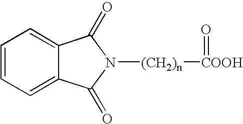
in which n can be from 1 to 18. In PAP n is 5.

Other preferred aromatic bleaches are substituted perbenzoic acids (e.g. meta-chloroperoxybenzoic acid, magnesium monoperoxyphthalate).

The bleach system may also comprise other components such as bleach activators to boost the action of the bleach. Examples of bleach activators are tetracetyl ethylene diamine (TAED), NOBS, acyl triethyl citrate, nonylamide of peradipic acid (e.g. as discussed in U.S. Pat. No. 4,259,201), sodium 3,5,5-trimethylhexanoyloxybenzene sulfonate (e.g. as discussed in U.S. Pat. No. 4,818,425), N-acyl caprolactams (acetoyl-undecanoyl caprolactams), imine and oxaziridine based bleach activators.

In addition, the system may include bleach catalyst to improve oxidation kinetics. Examples of bleach catalysts are complexes of transition metals such as Co, Mn and Fe.

The bleach system may additionally comprise a hydrophobic bleach compound. Examples are diacyl peroxides, (e.g. benzoyl peroxide), di-alkyl peroxides (e.g. di-tert-butyl peroxide), and peroxyesters (e.g. tert-butyl peroxy acetate).

In another aspect of the invention, the bleach is a hydrophilic bleach or precursors thereof. Preferably, the hydrophilic bleach is a perboric acid, percarbonic acid, hypochloric acid or a hypobromic acid; salts thereof; or precursors thereof. Hydrophilic bleaches and precursors thereof have been found to provide excellent cleaning performance in removing highly coloured soils, especially carotenoid soils, from plastic dishware. Carotenoid soils, such as α-, β-, γ-carotene and lycopene and xanthophylls (zeaxanthin or capsanthin), are derived from carrots and tomatoes and in any processed products containing these components, as well as certain tropical fruits and saffron.

Exothermically hydrating salts, such as for example K₂CO₃ or MgSO₄, may be used in combination with these hydrophilic bleaches, to generate heat when contacted with water, to increase the bleach activity.

The total amount of bleach in the composition applied to the substrate can range from 1 to 30%, preferably 3 to 20%, by weight of composition.

We find that the inclusion of bleach in the wipe provides the benefit of reduction of malodor. In particular, we find that inclusion of bleach reduces malodor from the wipe itself, which can otherwise arise after one or more uses.

In the present invention the bleach acts by formation of a peroxy anion. Thus it does not act by means of a free radical reaction (the composition applied to the substrate generally does not contain free radical initiators). The composition applied to the substrate is thus preferably such that in use it provides an alkaline aqueous environment, generally of pH from 8 to 12, preferably 8 to 10.

### Diamines

Another optional although preferred ingredient of the compositions according to the present invention is a diamine. Since the habits and practices of the users of detergent compositions show considerable variation, the composition will preferably contain at least 0.1%, more preferably at least 0.2%, even more preferably, at least 0.25%, even more preferably still, at least 0.5% by weight of said composition of diamine. The composition will also preferably contain no more than 15%, more preferably no more than 10%, even more preferably, no more than 6%, even more preferably, no more than 5%, even more preferably still, no more than about 1.5% by weight of said composition of diamine.

Preferred organic diamines are those in which pK1 and pK2 are in the range of 8.0 to 11.5, preferably in the range of 8.4 to 11, even more preferably from 8.6 to 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines. As a working definition herein, the pKa of the diamines is specified in an all-aqueous solution at 25° C. and for an ionic strength between 0.1 to 0.5 M.

### Polymeric Suds Stabilizer

The cleaning compositions of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from:

i) homopolymers of (N,N-dialkylamino)alkyl acrylate esters having the formula: 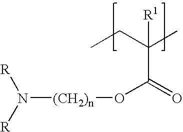
wherein each R is independently hydrogen, C₁-C₈ alkyl, and mixtures thereof, R¹ is hydrogen, C₁-C₆ alkyl, and mixtures thereof, n is from about 2 to about 6; and

ii) copolymers of (i) and 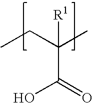
wherein R¹ is hydrogen, C1-C6 alkyl, and mixtures thereof, provided that the ratio of (ii) to (i) is from about 2 to about 1 to about 1 to about 2; Another preferred polymeric suds stabilizer is a copolymer of (i) and hydroxy ethyl acrylate or hydroxy propyl acrylate.

The molecular weight of the polymeric suds boosters, determined via conventional gel permeation chromatography, is from about 1,000 to about 2,000,000, preferably from about 5,000 to about 1,000,000, more preferably from about 10,000 to about 750,000, more preferably from about 20,000 to about 500,000, even more preferably from about 35,000 to about 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely 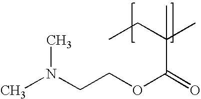
When present in the cleaning composition herein, the polymeric suds booster may be present in the composition from about 0.01% to about 15%, preferably from about 0.05% to about 10%, more preferably from about 0.1% to about 5%, by weight.

### Other Optional Ingredients

The cleaning composition may comprise additional ingredients selected from the group consisting of thickening polymers, film-forming polymers, cyclodextrin, colorants, perfume and perfume delivery agents, stabilizers, solvents, density control agents, drying agents, hydrotropes, salt, solidification agents, preservation agents, water spotting/filming/drying control agents, and mixtures thereof.

Thickening polymers may be employed to impart increases in the yield value or shear viscosity at a given shear rate. They may also improve smear and extrusion properties due to their viscoelastic nature in concentrated surfactant products. They also may assist in achieving the desired processing properties for such requirements as during application of the surfactant system to the substrate (die extrusion). Preferred examples of thickening polymers include those that have anionic side chains, and/or side chains which are anionic when in the cleaning composition itself, and preferably has a pKa in the range of 4 to 20.

Thus the side chains may be acid groups provided that the pKa of those acid groups is sufficiently low that under the pH conditions prevailing in the cleaning composition they are in the sort form. Generally acid groups having pKa 8.5 or below form anionic side chains in the cleaning composition and preferably pKa is not more than 8. Generally it is at least 4 and is preferably from 4 to 7. The side chains can be for instance carboxylate, sulfate or sulfonate and the polymer can be provided to the composition in the acid or the salt form provided that the salt form is present in the composition. Particularly preferred polymers include xanthan gum, cellulose, modified cellulose, guar gum, gum Arabic, polysaccharides, polyvinyl alcohols, polyvinyl pyrrolidone and mixtures thereof. An example of a thickening polymer is polyacrylic acid, commercially available as Carbopol ETD2623® from Noveon. The most preferred polymer is polyvinyl alcohol (PVA). The anionic charge is then formed in the composition by deprotonation of the hydroxyl groups, converting them to alkoxide groups having a pKa of between 8 and 14. The PVA preferably has a molecular weight of between 10,000 and 60,000 daltons, and is preferably partially hydrolysed to improve its dispersibility in the cleaning composition. The degree of hydrolysis is preferably 85% to 90%. In the partially hydrolysed form, PVA has both anionic and hydrophobic characteristics that are surfactant-like, resulting in excellent sudsing characteristics.

Film forming polymers may be employed to inhibit surfactant release, water migration, or prevent undesired environmental influences on the stability of the one or more components of the surfactant present in the cleaning composition. An example of a film forming polymer is polyvinylpyrrolidone (PVP) commercially available as Molwiol brand® from Clariant.

Cyclodextrin may be used to encapsulate peroxy carboxylic acid bleach or hydrophilic peroxy carboxylic acid bleach precursor. This can also provide the benefit of controlling release of bleach over time. Any of the known cyclodextrins can be used, for instance α-cyclodextrin, β-cyclodextrin and γ-cyclodextrin, with hydroxypropyl-beta-cyclodextrin and methyl-beta-cyclodextrin being preferred.

Stabilizers may be employed to protect one or more components of the surfactant system. Stabilizers may include butylated hydroxytoluene (BHT), butylated hydroxyanisole (BHA), sodium benzoate for radical scavenging, benzophenone-4 for color stability, and silicates for undesired surfactant aging. Benzophenone-4 is commercially available as UVINUL® MS-40 from BASF.

Solvents may be employed to control the phase chemistry of the surfactant system. Solvents examples such as polyethylene glycol, polypropylene glycol, and polybutylene glycol available from Dow Chemical.

Density control agents may be employed to modify the density of the phase(s) to improve stability. An example of a suitable density control agent is air or sodium sulfate available from Saskatchewan Minerals.

Drying agents may be employed to improve the aging and final properties of the surfactant. An example of a drying agent to bind free water is magnesium sulfate available from Aldrich.

Hydrotropes may be employed to modify the phase chemistry to improve stability or modify dissolution properties of the surfactant. An example of a hydrotrope is sodium cumene sulfonate Naxonate SC® available from Rutgers Organics.

Salts may be employed to modify the phase chemistry to improve stability or modify dissolution properties of the surfactant. Preferably, the salt added is a magnesium and/or calcium salt in order to provide magnesium and/or calcium to the cleaning composition. An example of a salt is magnesium chloride available from Dow Chemical.

Solidification agents may be used to improve the solid properties and rheology of the final surfactant. An example of a few solidification agents are stearyl alcohol sulfates (Lanette E® available from Cognis), stearyl alcohols available from P&G Chemicals, fatty acids like stearic acid available from P&G Chemicals, PEG 4000-20000 available from Dow Chemical/Union Carbide, sodium sulfate available from Saskatchewan Minerals, and the like.

Preservation agents may be employed to prevent microbial growth in the surfactant. An example of a preservative is methylchloroisothiazolinone/methylisothiazolinone mixture (Kathon CG/ICP-II® available from Rohm & Haas).

Water spotting and filming control agents may be employed to improve the final rinsing and subsequent drying. An example of a water spotting/filming agent is a copolymer of acrylic acid and methacrylic acid (Acusol 445N® available from Rohm and Haas). An example of a water drying agent is a tallow alcohol ethoxylate (18 mole EO) available from Texaco.

In a highly preferred embodiment according to the present invention, the cleaning composition additionally comprises 1,3-bisaminomethyl cyclohexane, magnesium and/or calcium ions, and poly(dimethylaminoethyl methacrylate) acetate.

### Process of Cleaning Dishware

The present invention also encompasses a process of cleaning dishware, preferably to a process of cleaning dishware by hand.

This process comprises the steps of: a) wetting the wipe according to the present invention with water and b) contacting the dishware with the wetted wipe.

Additionally the process of cleaning dishware herein additionally comprises the step of mechanically agitating the wipe over said dishware (wiping) and/or rinsing said dishware with water.

In a preferred embodiment, the present invention also relates to a process of cleaning a hard surface, preferably a kitchen hard surface. The process of cleaning a hard surface comprises the steps of: a) wetting the wipe according to the present invention with water and b) contacting the hard surface with the wetted wipe. Additionally the process of cleaning a hard surface herein additionally comprises the step of mechanically agitating the wipe over said hard surface (wiping) and/or rinsing said hard surface with water.

The wipes of the present invention are water-activated and are therefore intended to be wetted with water prior to use. As used herein, “water-activated” means that the present invention is presented to the consumer in dry form to be used after wetting with water. Accordingly, the article is wetted by immersion in water or by placing it under a stream of water.

### EXAMPLES

The following examples further describe and demonstrate embodiments within the scope of the present invention. In the following examples, all ingredients are listed at an active level. The examples are given solely for the purpose of illustration and are not to be construed as limitations of the present invention, as many variations thereof are possible without departing from the spirit and scope of the invention.

Prepare a representative wipe according to the present invention in the following manner: The preferred wipe comprises 6 layers of substrate. The first layer substrate is a spunlace blend of 40% viscose rayon and 60% polypropylene fibers, having a basis weight of about 60 gsm. This layer is pre-printed with the active graphic using the flexographic printing mechanism. The second and fourth layers comprise low density polyethylene (LDPE) film of 19 gsm. The third and fifth layers are made from air-laid, lofty, low density nonwoven comprises a mixture of polyethylene terephthalate (PET) and PET-polyetheylene bicomponent fibers. The thickness of the batting is about 0.1 to 0.2 in. measured at 5 gsi (grams per square inch). The sixth layer of substrate is a clear polypropylene/EVA scrim mesh of 30 gsm.

The first cleaning composition, detailed below, is applied to the surface of the batting layer which is not in connection with the LDPE film. The cleaning composition is in the form of a paste and applied to the wipe substrate in stripes. The cleaning composition is applied to one side of the batting layer of the substrate by extruding it through a coating head continuously in five lines about 12 mm wide separated by a distance of 20 mm, measuring widthwise across the web, making parallel lines on each side of the web. The cleaning composition is extruded at a rate to yield 1.0 gram of first cleaning composition per wipe. The first composition is applied in two stripes of 1500 mm2 each giving a total paste application area of 3000 mm2.

The second cleaning composition, detailed below, is applied to one side of the batting layer which is in connection with the LDPE film. The composition is applied by continusouly extruding it through a coating head in five lines about 12 mm wide separated by a distance of 20 mm, measuring widthwise across the web, making parallel lines on each side of the web. The cleaning composition is extruded at a rate to yield 3.5 grams of cleaning composition per finished article.

The layer of substrate that carries the second cleaning composition (slow release paste) is enclosed between two water insoluble LDPE films. This sandwich layer is fed over the substrate containing the 1^{st} cleaning composition placing the film sandwich in contact with the side of the substrate where the first composition was applied to. The substrate layers are continuously fed to an ultrasonic sealer, which seals a dot pattern comprising a grid of 8 mm long sealing points spaced evenly across the web. The web is cut into individual wipes measuring about 120 mm×160 mm rectangles with rounded corners, which has a total of about 70 sealing points per article.

First Composition: Fast Release paste

| Ingredient | % Weight |
|---|---|
| Sodium Alkyl Ethoxy_{0.6} | 46.89 |
| Sulfate | |
| C₁₀₋₁₆ dimethyl amine oxide | 10.62 |
| C₁₁E₉ nonionic | 3.54 |
| Diamine | 0.89 |
| PolyDMAM polymer | 0.36 |
| Sodium cumene Sulfonate | 1.50 |
| Polypropylene glycol | 1.50 |
| mol wt 3000 | |
| Perfume | 2.00 |
| Sandolan Blue dye EHRL 180 | 0.05 |
| Miscellaneous (water) | 31.60 |
| TOTAL | 100 |

Diamine is 1,3 bis (methylamine)-cyclohexane.
Poly DMAM is (N,N-dimethylamino) ethyl methacrylate homopolymer

### Second Composition: Slow Release Paste

Second composition: Slow release paste

| Component | Wt % |
|---|---|
| Sodium Alkyl Ethoxy_{0.6} Sulfate | 63.62 |
| C₁₀₋₁₆ dimethyl amine oxide | 14.41 |
| C₁₁E₉ nonionic | 4.97 |
| Diamine¹⁾ | 1.2 |
| Poly DMAM²⁾ | 0.48 |
| Polyvinyl alcohol | 2.0 |
| Perfume | 2.0 |
| Blue Dye | 0.000872 |
| Yellow Dye | 0.0000884 |
| Water | 13.00 |

Diamine¹⁾ is 1,3 bis (methylamine)-cyclohexane.
Poly DMAM²⁾ is (N,N-dimethylamino) ethyl methacrylate homopolymer

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. It will be clear to those skilled in the art that various changes and modifications may be made without departing from the scope of the invention and the invention is not to be considered limited to the embodiments and examples that are described in the specification.

1. A dishwashing wipe comprising a water insoluble substrate and at least a first and a second surfactant-containing cleaning composition, wherein the first composition releases surfactant at a rate of at least 0.6 g surfactant/minute and the second composition releases surfactant at a rate of 0.5 g surfactant/minute or less.

2. A dishwashing wipe according to claim 1 wherein the first composition releases surfactant at a rate of from 0.6 g to 4.0 g surfactant/minute.

3. A dishwashing wipe according to claim 1 wherein the second composition releases surfactant at a rate of from 0.005 g to 0.5 g of surfactant/minute.

4. A dishwashing wipe according to claim 1 wherein the first composition comprises a dissolution aid selected from the group consisting of: at least 15% water, hydrotope, diols, monohydric alcohols, polyglycols, and mixtures thereof.

5. A dishwashing wipe according to claim 4 wherein the dissolution aid is selected from the group consisting of: sodium benzene sulphonate, sodium xylene sulphonate, sodium cumene sulphonate, sodium naphthalene sulfonate, cyclohexane dimethanol, trimethyl pentane diol, tetramethyl pentane diol, 1,6 hexane diol, ethanol, propanol, butanol, pentanol, hexanol, polyethylene glycol of molecular weight between 200 and 4000, polyethylene glycol adipate, polypropylene glycol of molecular weight between 1000 and 3000, polybutylene glycol, and mixtures thereof.

6. A dishwashing wipe according to claim 4 wherein the second composition comprises a dissolution-retarding agent selected from the group consisting of: less than 12% water, polymers, inorganic salts, and mixtures thereof.

7. A dishwashing wipe according to claim 6 wherein the dissolution-retarding agent is selected from the group consisting of: xanthan gum, cellulose, modified cellulose such as methyl cellulose, hydroxyl propyl methyl cellulose, guar gum, gellan, carragheenan, gum arabic, polacrylates, polyacrylate/maleate copolymers, polyvinylalcohol/acetate copolymers, polyaspartic acid polymers, polyvinyl pyrrolidone, poly vinyl pyridine N-oxide, polyethylene glycol polymers of molecular weight greater than 8000 and mixtures thereof, fumed silica (SiO2), diatomaceous earth (SiO2), talc (MgAlSiO3), calcium carbonate, calcium or magnesium hydroxide, sodium silicate, sodium borate, and mixtures thereof.

8. A dishwashing wipe according to claim 1 where in the water-insoluble substrate comprises more than two layers.

9. A dishwashing wipe according to claim 8 wherein the substrate comprises at least two layers of water insoluble, water impermeable or semi-permeable film.

10. A dishwashing wipe according to claim 8 wherein the second composition is substantially located between two layers of substrate.

11. A dishwashing wipe according to claim 1 wherein the substrate comprises at least two external surfaces, and the first composition is applied to at least one external surface of the substrate.
